(19) United States
(12) Patent Application Publication
(10) Pub. No.: US 2014/0010603 A1
(43) Pub. Date: Jan. 9, 2014

(54) Portable Materials Storage Tank for Use With Vacuum Truck Pneumatic Transfer System

(71) Applicant: BM Metals Services Inc., Sudbury (CA)

(72) Inventors: Denis BLAIS, Sudbury (CA); Shayne Smith, Sudbury (CA)

(73) Assignee: BM Metals Services Inc.

(21) Appl. No.: 13/919,045

(22) Filed: Jun. 17, 2013

Related U.S. Application Data
(63) Continuation-in-part of application No. 13/549,603, filed on Jul. 16, 2012.

(30) Foreign Application Priority Data
Jul. 5, 2012 (CA) 2782443

(51) Int. Cl. B60P 1/60

(52) U.S. Cl. CPC B60P 1/60
USPC 406/39

(57) ABSTRACT

A portable storage tank for use with a vacuum truck for the collection and discharge of a waste particulate material which includes a storage tank, waste collection and discharge assemblies and an air pump assembly. The air pump assembly is operable to induce negative and positive pressures within the storage tank. The collection assembly includes a vacuum inlet for fluid flow between the vacuum inlet and the storage tank inlet during air pump operation to induce said negative pressure. The waste discharge assembly includes a discharge conduit for conveying a pressurized fluid flow and entrained collected material from a tank materials outlet to an outlet end while the air pump assembly is operated to induce a positive pressure.

### RELATED APPLICATIONS

This application is a continuation-in-part of a U.S. patent application Ser. No. 13/549,603, filed 16 Jul. 2012.

### SCOPE OF THE INVENTION

The present invention relates to a truck transportable materials storage tank assembly for use with a vacuum-type collector, and more particularly a vacuum truck pneumatic transfer system for the collection, storage, transportation and subsequent discharge of a particulate material, and preferably spillage and/or waste material from steel making, mining and/or ore processing operations.

### BACKGROUND OF THE INVENTION

Vacuum trucks for the collection and transport of solid waste materials are known. Such trucks are typically provided with a material collection or waste storage tank which is mounted on a truck frame or chassis. A vacuum source is provided to draw air into the storage tank from a suction or vacuum inlet placed in proximity to the material to be collected. Following collection, the truck is thereafter used to move the collected material to either a disposal or waste recycling site, where the collected material is discharged.

To discharge the collected material from the storage tank, various systems have been proposed. In a most simplified design, the storage tank is provided with a cleanout door which provides access to the storage tank interior, and which may be opened to allow the collected material to be manually removed. In addition, various mechanical systems for emptying waste storage tanks have also been proposed. Such mechanical cleanout systems include hydraulic lift systems which are operable to tilt or incline one end of the storage tank, to facilitate the gravity discharge of collected material. In other designs, storage tanks are provided with screw discharge augers which mechanically convey collected solid materials from within the storage tank interior.

While conventional vacuum truck designs have proven suitable for use in the collection of municipal waste, litter and the like, heretofore such apparatus have presented various difficulties in the collection, transportation and recycling or reuse of spillage and/or waste mining or ore processing revert material. In particular, revert material produced in the mining, ore processing, steel making and other similar processes frequently contains a significant portion, and typically 10 to 50%, of particulates dust and fine powders less than 0.5 cm in diameter. The use of conventional vacuum trucks in the collection of such revert materials frequently results in the loss of significant volumes of revert fines by air entrainment and dissipation.

In particular, with conventional vacuum truck designs, fine powders and dust becomes entrained within the air when the storage tank is emptied as a result of the storage tank design. In particular, as the storage tank is opened to the atmosphere and emptied, significant portion of such materials may become entrained and subsequently become air borne, escaping via the storage tank access doors, discharge auger outlets and the like. In addition to a loss of commercially valuable material from recycling process streams, the escape of entrained revert materials from conventional vacuum trucks may present environmental concerns, particularly where such trucks are used in enclosed or confined spaces, such as within underground mine operations, or inside steel processing or industrial facilities.

In addition, conventional vacuum truck designs do not allow for the economical short term or long term storage of collected materials. Rather, by their design, once used to collect the waste material, existing vacuum trucks must typically be immediately driven to a waste or recycling facility for off-loading.

### SUMMARY OF THE INVENTION

In one possible construction, the present invention provides for a mobile system for the collection, transport and discharge of waste and/or particulate materials, and which is provided with a materials storage tank assembly which includes vacuum-based waste collection assembly. To overcome at least some of the difficulties associated with conventional vacuum truck designs, preferably, the collection assembly is provided for suction collection and pneumatic discharge of particulate waste or revert material produced in steel making, mining or ore processing operations.

In another possible construction, the present inventions provides for a portable material storage tank assembly which is adapted to be used in conjunction with the vacuum system of a vacuum truck or other suitable evacuating air pump assembly, in the collection optional storage and discharge of a waste particulate material. Preferably, the materials storage tank assembly is provided with a support frame so as to be mounted on to and demounted from a truck bed, and more preferably the bed of a roll truck.

The materials storage tank assembly includes a storage or collection tank for the storage and transport of collected waste material and a pneumatic based waste discharge assembly which is configured to assist in the discharge and/or emptying of collected material stored in the storage tank, for disposal, reuse or recycling.

Although not essential, more preferably the discharge assembly is provided with a discharge conduit having an outlet which is adapted for direct coupling to an infeed pipe, hopper or storage silo of a recycling facility. More preferably, the discharge assembly is provided for the discharge and/or conveyance of collected revert material from the storage tank to a further processing or reprocessing facility in a discharge flow or stream which is substantially sealed from the atmosphere.

In accordance with one possible non-limiting object of the invention, another possible construction provides a vacuum truck assembly which is adapted for the collection and transport of revert materials produced in mining, ore processing or metal making operations, and which is suitable for use in confined indoor and/or underground mine environments.

Another non-limiting object of the invention is to provide a particulate material collection and discharge assembly for use with a vehicle based or transportable collector or storage tank assembly, and which incorporates a pneumatic-based transfer system to facilitate the removal and/or discharge of collected particulate material from the interior of the collector or storage tank.

In another non-limiting aspect, the present invention provides a vacuum truck which is adapted for the collection, transportation and subsequent discharge of waste materials having a substantial particulate fine powder and/or dust portion, and which is adapted to minimize the re-entrainment or escape of such fine waste particles into the atmosphere during collection and/or discharge.

In another non-limiting construction, the present invention provides for a truck mountable/demountable materials storage tank which is adapted for the collection, optional storage, transportation and subsequent discharge of waste materials, such as mine reverts, waste rock, tailings, minerals and the like, and which allows for the economical collection and short term and/or long term storage of the collected materials either on site, or at a storage or recycling facility, prior to the discharge of the collected waste therefrom.

Accordingly, in one aspect, the present invention resides in a vacuum truck for the collection, transport and discharge of a waste particulate material to be collected, the vacuum truck including: a materials storage tank mounted on a truck frame, a waste collection assembly, a waste discharge assembly, and an air pump assembly selectively operable to induce either a negative or positive pressure within an interior of said materials storage tank, the storage tank having a materials inlet and a materials outlet, the waste collection assembly including a vacuum inlet disposed for the vacuum fluid flow between the vacuum inlet and the storage tank inlet during operation of the air pump assembly to induce said negative pressure, whereby the vacuum conduit communicates said vacuum fluid flow from said vacuum inlet to carry an entrained portion of said particulate material with said vacuum fluid flow into an interior of said storage tank as stored material, the waste discharge assembly including a discharge conduit assembly for conveying a pressurized fluid flow moving from the storage tank materials outlet to an assembly outlet end while the air pump assembly is operated to induce said positive pressure, the discharge conduit assembly including a discharge conduit for receiving the pressurized fluid flow to carry said stored material entrained therein to said outlet.

In another aspect, the present invention resides in a particulate material collection and discharge assembly for use with a vehicle based vacuum collector tank having a materials inlet and a materials outlet, the collection and discharge assembly including: an air pump assembly, a vacuum inlet, a vacuum conduit, a discharge conduit assembly including a discharge conduit extending from an inlet end to an outlet end, the air pump assembly being selectively operable to induce a positive pressure in said collector tank, the vacuum inlet being positionable for the vacuum collection of particulate material along the ground, the vacuum conduit providing a fluid flow between the vacuum inlet and the collector tank inlet while a vacuum is applied to induce said negative pressure in said collector tank, whereby the vacuum conduit communicates vacuum air flow from said vacuum inlet to carry an entrained portion of said particulate material therewith into the collector tank interior as stored material, the discharge conduit for conveying pressurized air flow moving from the materials outlet to the outlet end while or after the air pump assembly is operated to induce said positive pressure in said collector tank, the communication of said pressurized air flow from said materials outlet operating to carry a portion of said stored material therewith outwardly from said collector tank interior via the outlet end.

In a further aspect, the present invention resides in a mine revert collector truck assembly for the collection, transport and discharge of mining reverts, the assembly including: a materials collector tank mounted on a truck frame, a reverts collection assembly, a reverts discharge assembly, and an air pump assembly selectively operable to induce negative and positive pressures within an interior of said materials collector tank, the collector tank having a materials inlet and a materials outlet, the waste collection assembly including a vacuum inlet disposed for the vacuum fluid flow between the vacuum inlet and the storage tank inlet during operation of the air pump assembly to induce said negative pressure, whereby the vacuum conduit communicates said vacuum fluid flow from said vacuum inlet to carry an entrained portion of said particulate material with said vacuum fluid flow into an interior of said storage tank as stored material, the waste discharge assembly including a discharge conduit having a discharge outlet end for providing pressurized fluid flow between the storage tank materials outlet and the discharge outlet end during operation of the air pump assembly to induce said positive pressure, whereby the discharge conduit communicates the pressurized fluid flow from said materials outlet to carry at least part of said stored material entrained with said pressurized fluid flow outwardly from said storage tank interior via said discharge outlet end.

In yet another aspect, the present invention resides in a truck mountable/demountable materials storage tank assembly for the collection, storage and discharge of waste particulate material to be collected, the materials storage tank assembly including: a storage tank defining a tank interior and having a materials inlet and a materials outlet; a waste collection assembly; a waste discharge assembly; and a support frame for movably supporting said storage tank, said waste collection assembly and said waste discharge assembly as a portable unit, the storage tank assembly being adapted for selective coupling to both a pressurizing air pump assembly operable to induce a positive pressure within the tank interior, and an evacuating air pump assembly operable to induce a negative pressure in said tank interior, the waste collection assembly including a vacuum inlet positionable to receive therein said waste particulate material to be collected and a vacuum conduit operable to provide fluid communication between the vacuum inlet and the materials inlet, when said evacuating air pump assembly is coupled to the storage tank assembly to induce said negative pressure in said tank interior, whereby on inducement of said negative pressure in said tank interior, the vacuum conduit communicates a vacuum fluid flow from said vacuum inlet to carry an entrained portion of said particulate material to be collected therewith into the tank interior, the waste discharge assembly including an outlet end and a discharge conduit operable to provide fluid communication between the materials outlet and the outlet end, whereby when said pressurizing air pump assembly is coupled to the storage tank assembly to induce said positive pressure in said tank interior, the discharge conduit communicates a pressurized fluid flow to assist in carrying particulate material collected in said tank interior therewith to said outlet end, and the support frame supporting said storage tank, said waste discharge assembly in a position elevated a distance above the ground.

In still a further aspect, the present invention resides in a portable materials storage tank assembly for the collection, storage and discharge of waste particulate material to be collected, the materials storage tank assembly including, a storage tank defining a tank interior and having a materials inlet, a materials outlet and a suction inlet, each of the materials inlet, materials outlet and suction inlet providing selective communication with the tank interior, a waste collection assembly comprising a vacuum conduit in fluid communication with the materials inlet having a vacuum inlet being positionable to collect and receive therein at least part of said material to be collected, a waste discharge assembly including a discharge conduit in fluid communication with said materials outlet and having an upstream end and a downstream outlet end, a support frame supporting said storage tank, said waste collection assembly and said waste discharge assembly as a portable unit for transport, the suction inlet being adapted for fluidic coupling to an evacuating air pump assembly operable to induce a negative air pressure in said tank interior, whereby fluid communication between the vacuum conduit and the tank interior effects a vacuum fluid flow into the vacuum inlet to carry an entrained portion of said particulate material therewith from said vacuum inlet into the tank interior, the storage tank assembly being adapted for fluidic coupling to a pressurizing air pump assembly operable to induce a positive pressure within said tank interior, whereby fluid communication between said materials outlet and said tank interior effects a pressurized fluid flow from the materials outlet to assist in carrying particulate material collected in the tank interior therewith into the discharge conduit and from the material outlet end.

### BRIEF DESCRIPTION OF THE DRAWINGS

Reference may now be had to the following detailed description taken together with accompanying drawings, in which:

FIG. 1 shows a schematic side view of a vacuum truck in accordance with a first preferred embodiment of the invention;

FIG. 2 shows an enlarged partial perspective view of the rear-end of the vacuum truck of FIG. 1;

FIGS. 3 and 4 show a schematic view of a float ball valve used in the sealing of the storage tank vacuum inlet during the pressurization and depressurization of the truck debris collection and storage tank in discharge and vacuum operations;

FIG. 5 shows an enlarged partial perspective side view of the collection tank rearward end, illustrating the sealing assembly used in the securement of the collection tank access door;

FIG. 6 shows a partial cross-sectional view of the collection tank shown in FIG. 5, taken along lines 6-6′, illustrating a sealing clamp used in the cover sealing assembly of FIG. 5;

FIG. 7 shows an enlarged partial perspective rear-end view of the vacuum truck of FIG. 1, with a discharge outlet end of the truck waste discharge assembly fluidically coupled to a revert storage silo infeed pipe during material discharging operation;

FIG. 8 shows a perspective view of the vacuum truck collection tank access door and waste discharge assembly shown in FIG. 1;

FIG. 9 shows a schematic side view of a vacuum truck in accordance with a further embodiment of the invention;

FIG. 10 shows a partially cutaway schematic view of a roll-truck mountable/demountable material storage tank assembly in accordance with an alternate embodiment of the invention;

FIG. 11 shows a partial perspective rear end view of the materials storage tank assembly shown in FIG. 10 in isolation; and

FIG. 12 shows a partial schematic view of the materials storage tank assembly shown in FIG. 10, fluidically coupled to the section inlet hose of a vacuum truck in the collection of waste particulate material.

### DETAILED DESCRIPTION OF THE PREFERRED EMBODIMENTS

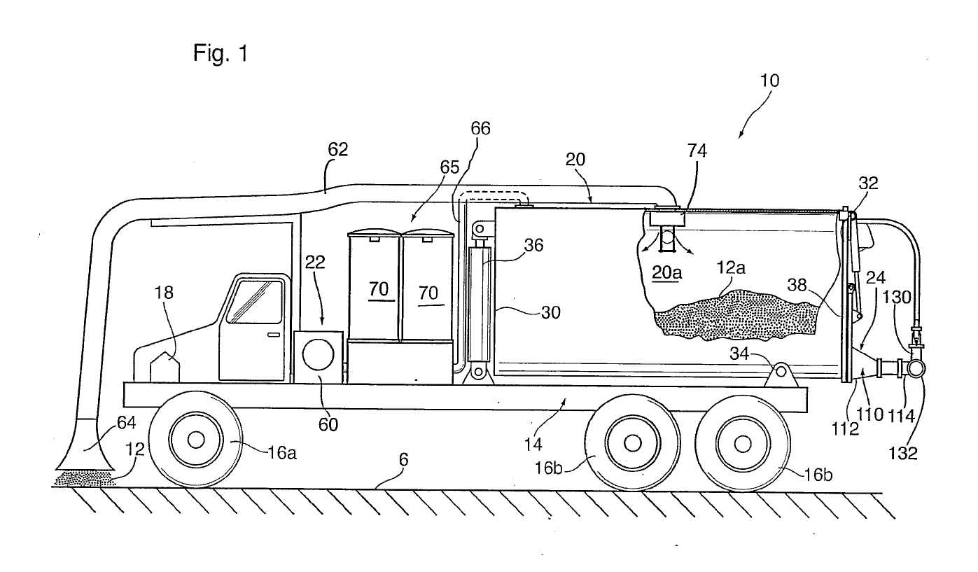

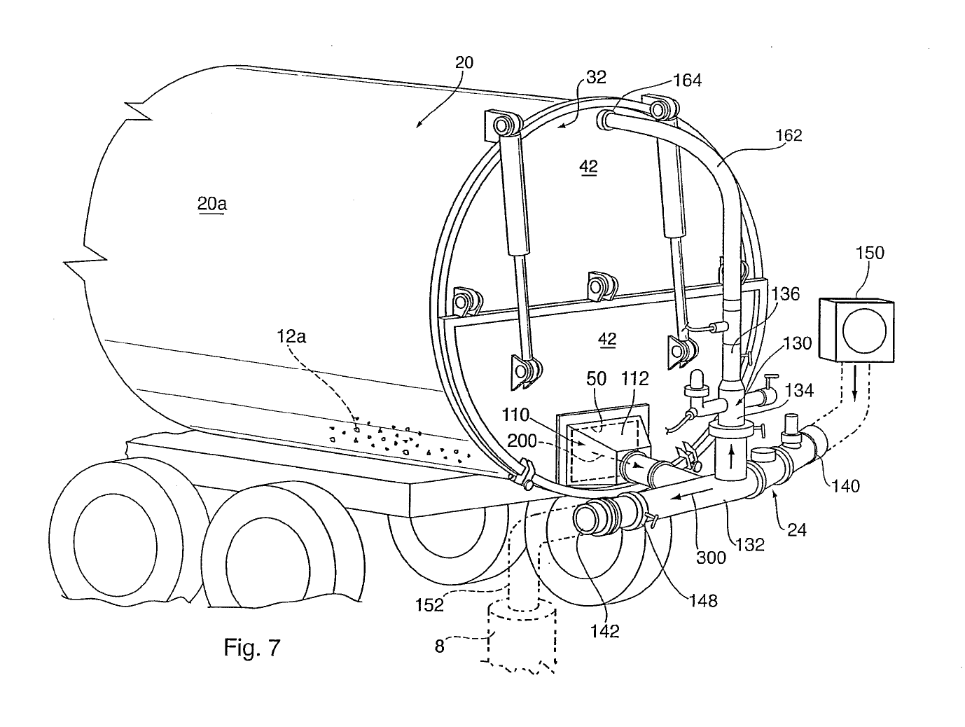

Reference is made to FIG. 1 which illustrates a vacuum truck 10 for use in the collection, transport, and subsequent discharge of particulate waste revert material 12 produced in underground mining operations in accordance with a preferred embodiment. As will be described, in operation the truck 10 is operable to collect particulate revert material 12 off of the ground 6 and store it for transport and subsequent discharge into a remote storage silo 8 (FIG. 7) located at a recycling or processing facility.

The truck 10 includes a truck frame 14 mounted on front and rear sets of ground wheels 16a,16b, and although not essential, is most preferably powered in both movement and vacuum operation by way of a diesel motor 18. The vacuum truck 10 is provided with material storage or collection tank 20, a pneumatic waste collection assembly 22 and a pneumatic waste discharge assembly 24 mounted on the frame 14.

FIG. 1 shows best the collection tank 20 as having a generally cylindrical construction extending from a closed forward end 30 to a rearward end 32. Although not essential, most preferably the entire collection tank 20 is pivotally mounted to the frame 14 by way of rear hinge mounts 34, and at its forward end 30 by a hydraulic lift cylinder 36. The hydraulic lift cylinder 36 is selectively operable to raise the forward end 30 relative to the rearward end 32 to facilitate the discharge and emptying of collected revert material 12a from the tank interior 20a.

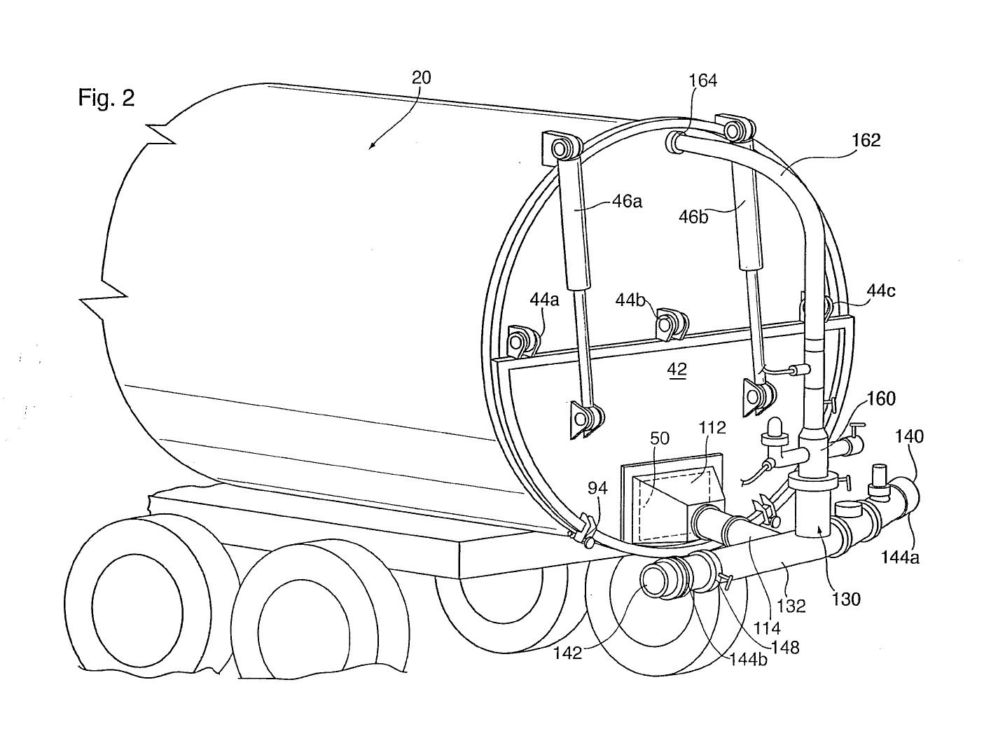

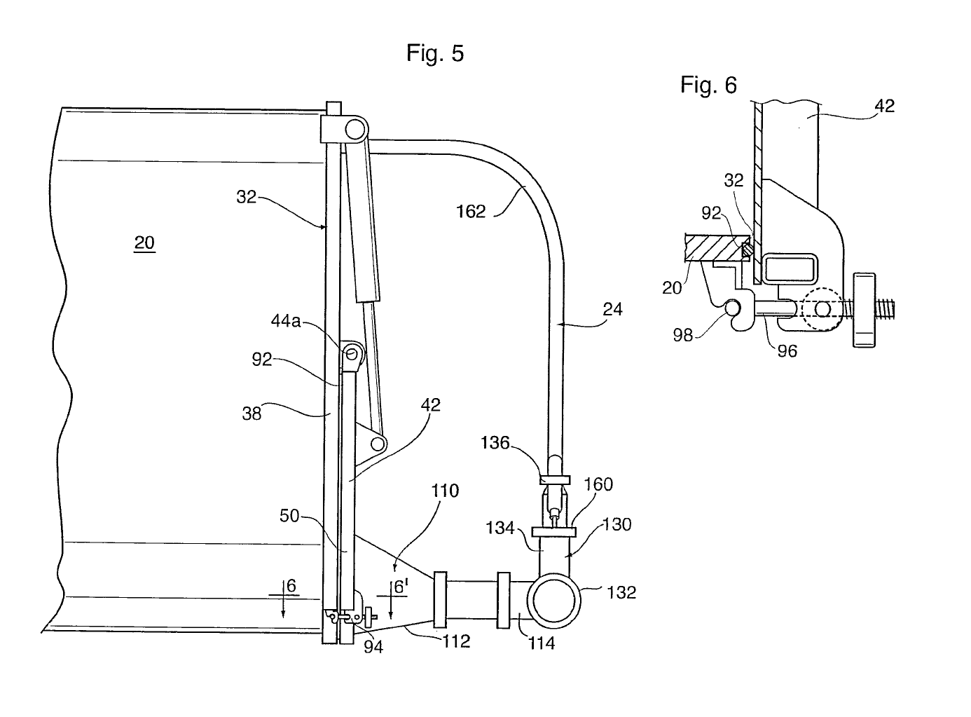

An access opening 38 is formed in the lower half of the rearward end 32 of the collection tank 20. As shown best in FIGS. 2 and 5 a hinged cover 42, which functions as a tailgate, is pivotally movable about hinges 44a,44b,44c to selectively allow access to the tank interior 20a for periodic maintenance or even emptying, depending on the waste material 12 collected. As shown best in FIG. 2, the hinged cover 42 is selectively movable between open and closed positions by the operation of a pair of hydraulic lift arms 46a,46b. The activation of the lift arms 46a,46b allows the cover 42 to pivot about the hinges 44a,44b,44c moving from the closed position shown to a raised position, to allow access into the tank interior 20a via opening 38.

FIG. 2 shows best a lower discharge cut-out or outlet 50 being formed through a lower extent of the hinged cover 42. The hinged cover 42 is preferably provided with the lower cut-out or outlet 50 which is provided to allow for the discharge of collected revert particles 12a (FIG. 7) from the tank interior 20a through the cover 42 and into the discharge assembly 24, without requiring activation of the lift arms 46a,46b. Optionally the hinged cover 42 may be provided with suitable reinforcing ribs, struts, or tubes to provide enhanced structural integrity about the cut-out 50.

FIG. 1 shows best the waste collection assembly 22 and including a vacuum air pump 60, a suction inlet hose 62, suction nozzle 64 and bag collection housing 65. The vacuum air pump 60 is mounted on the truck frame 14 immediately forward of the collection tank 20. The air pump 60 is provided in fluid communication with an upper region of the collection tank 20 via a vacuum hose 66. The vacuum air pump 60 is of a conventional design and type selected such that when operated, the vacuum air pump 60 generates a desired high negative vacuum pressure within the tank interior 20a. Although not essential, preferably the vacuum hose 66 is provided in fluid communication with suction nozzle formed in an upper region of the dust bag collection housing 65 which in turn is provided in fluid communication with the tank interior 20a, via a flow passage located adjacent the forward end 30. The dust bag collection housing 65 is provided with one or more filter bags 70 selected to prevent the collected dust or fine revert particles 12a from being drawn therepast into the air pump 60.

The suction inlet hose 62 as provided in fluid communication at its forwardmost end with the suction nozzle 64, and at its rearward end with an inlet opening 74 formed through the top wall of the collection tank 20. As shown best in FIG. 1, the suction nozzle 64 is most preferably positionable adjacent to the ground 6. In one construction, the nozzle 64 is fixed in position ahead of the front set of ground wheels 16a with vacuuming performed with the truck 10 in motion. More preferably, however, the nozzle 64 is provided at the end of a movable inlet hose 62 which permits the physical manipulation and/or extension of the nozzle 64 upto 50′ or more away from the truck 10 during vacuuming operations. In an alternate construction the inlet hose 62 may include one or more detachable hose extensions which allow for the suction nozzle 64 to be used and/or manually moved over a variety of distances from the storage tank 20, to reach remote locations.

It is to be appreciated that the suction nozzle 64 and inlet hose 62 are configured so that on operation of the vacuum air pump 60 to impart a negative pressure within the tank interior 20a, air is drawn inwardly through the suction nozzle 64 with a sufficient velocity to effect the entrainment and lifting of the particulate material 12. In this manner, the suction nozzle 64 may be manually moved over the particulate materials in the manner of a workshop vacuum. The collected revert material 12 is carried along the suction hose 62 and through the inlet opening 74 into the storage tank 20. On entering the tank interior 20a, the airflow velocity decreases allowing the collected particulate material 12a to collect along the tank bottom. It is to be appreciated that if desired, the collection tank 20 could also be provided with internal baffling and/or cyclone structures (not shown) to facilitate the settling of collected fine particles 12a within the tank interior 20a.

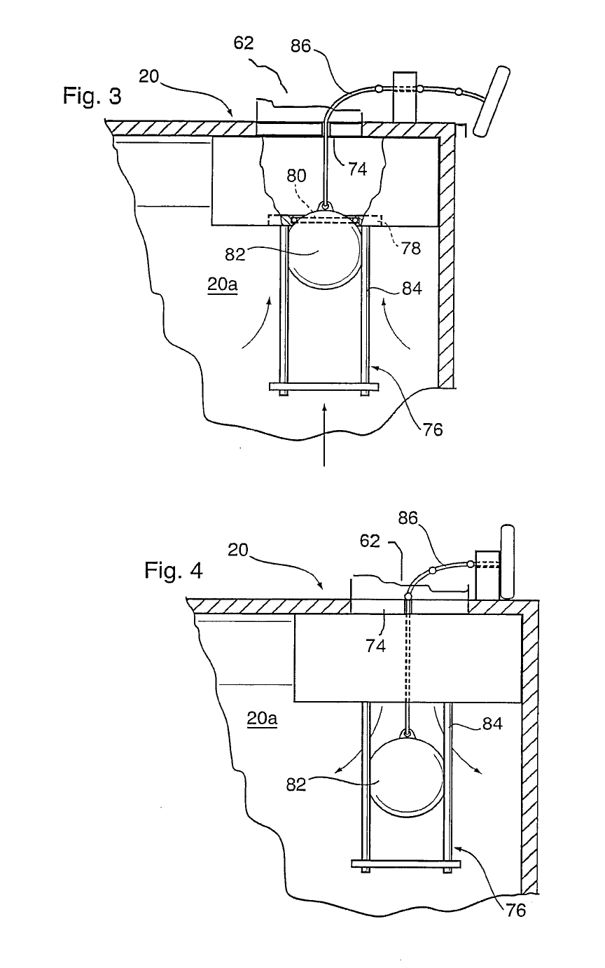

FIGS. 3 and 4 show best a float ball assembly 76 as being secured along the top wall of the collection tank 20 over the inlet opening 74. The float ball assembly 76 includes as a valve seat, a steel ring plate 78 which extends circumferentially about an air passage leading through opening 74, a float ball 82 and a retention cage 84. The ring plate 78 is used to mount a resiliently compressible rubber gasket 80. The float ball 82 is secured for selective movement within the ball cage 84 between a lowered position shown in FIG. 4 and a raised position shown in FIG. 3 by a chain 86 or other connecting cord. The chain 86 is used to manually raise and connect the float ball 82 to the tank sidewall. The chain 86 has a length selected to allow the ball 82 to be manually drawn upwardly and secured in position against the gasket 80 during tank pressurization. In the normal course, the chain 86 is used to suspend the ball 82 in the position shown in FIG. 4 when the vacuum air pump 60 is activated to place the tank interior 20a under a negative pressure. In such a lowered position, the ball 82 is spaced from the rubber gasket 80 to permit air and particle flow to move from the suction inlet hose 62 through the inlet opening 74 and into the collection tank interior 20a.

Once the vacuum air pump 60 is turned off, the chain 86 may be used to manually raise the ball 82 to the raised position, until the float ball 82 is moved upwardly into sealing contact with the rubber gasket 80, preventing the return flow of air from the tank interior 20a outwardly via the tank inlet opening 74. Optionally, a spring (not shown) may be used to ensure the float ball 82 to assist in its guiding movement between raised and lowered positions.

It is to be appreciated the float ball assembly 76 advantageously also operates in conjunction with the pneumatic discharge assembly 24, to assist in the pressurization of the tank interior 20a to a positive pressure, facilitating the discharge of collected reverts 12a therefrom.

Although not essential, most preferably a fluid sealing assembly is provided to maintain a substantially fluid impervious seal between the cover 42 when closed, and the adjacent rearward end 32 of the storage tank 20. FIGS. 5 and 6 show best the sealing assembly as including compressible gasket seal 92 and number of cooperating releasable hooks 94 spaced along the lower edges of the cover 42. The gasket seal 92 (FIG. 6) is formed as a compressible elastomeric strip which extends about the entire peripheral edge of the end cover 42. Each of the hooks 94 act in conjunction with the cross head of 98 of a mechanical fastening dowel or rod 96 which engages a respective hook 94. In the normal operation of the vacuum truck 10, fasteners 96 are provided in a position engaging adjacent pairs of hooks 94 to mechanically secure the cover 42 in a closed position over the access opening 38.

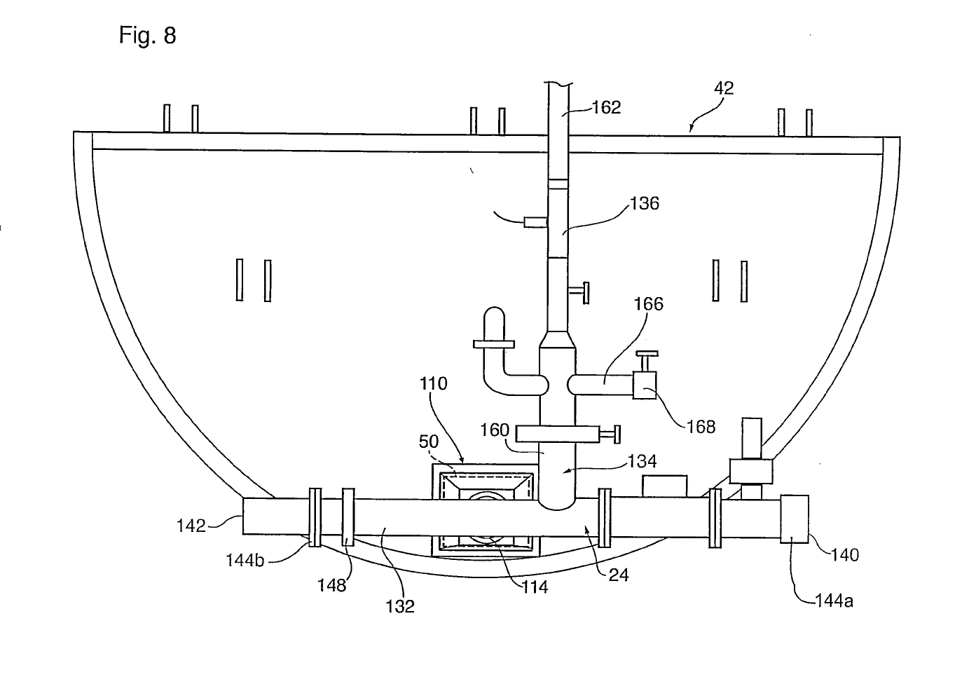

FIGS. 7 and 8 show best the pneumatic discharge assembly 24 used in the discharge of collected revert particles 12a from the tank interior 20a. The discharge assembly 24 includes an enclosed reverts discharge chute 110, and a pressurizing manifold assembly 130 which are primarily caused by the end cover 42. The discharge chute 110 is secured to the end cover 42 in a substantially sealing position over the cut-out aperture 50. The chute 110 includes a rearwardly sloped hopper box 112 which is fluidically coupled at an outermost end to outlet pipe 114. The outlet pipe 114 is preferably formed as a 4 to 6 inch diameter round pipe which, when the end cover 42 is closed, slopes marginally in a downward orientation away from the hopper box 112.

The manifold assembly 130 is used both in the pressurization of the storage tank interior 20a as well as the pneumatic conveyance of collected revert particles 12a as they are discharged therefrom. The manifold assembly 130 is shown best in FIG. 8 as including a generally horizontally arranged pressurizing discharge pipe 132, a pressure diverter pipe 134 and a shut-off valve 136. The pressurizing discharge pipe 132 extends as a 4 to 6 inch diameter pipe from an air flow inlet end 140 to a discharge outlet end 142. Most preferably an outlet valve 148 is provided adjacent to the outlet end 142, and which is actuable between open and closed positions to selectively permit or prevent air and/or particulate flow therepast and outwardly from the outlet end 142. Preferably, the discharge pipe 132 is mounted in a generally horizontal orientation or is inclined in a slightly downward inclined orientation, so as to slope at an inclined angle of upto 10° towards the outlet end 142. Although not essential, preferably each end 140,142 is provided with associated quick release camlock coupling 144a,144b. As will be described, the coupling 144a is provided for rapid fluidically connecting the inlet end 140 to a pressurizing air source or pump 150 (FIG. 7). The pressurizing air pump 150 may be mounted on the truck frame 14, with the vacuum truck 10 operating a single integral unit. In an alternate construction, the pressurizing air source 150 may be provided as a stand-alone pump or pressurizing air source located at a revert storage and/or discharge facility. Coupling 144b is most preferably configured to enable the rapid fluidic coupling of the outlet end 142 of the discharge pipe 132 directly of a tubular feed connector or hopper fitting (shown in phantom as 152) of the storage silo 8 during discharge of the collected revert particles 12a from the storage tank 20.

FIG. 8 shows best both the outlet pipe 114 and pressure diverter pipe 134 as being fluidically coupled to the pressurizing discharge pipe 132 between the inlet and outlet ends 140,142. The pressure diverter pipe 134 includes a rigid diameter lower section 160 and a flexible section 162 which are provided in selective fluid communication and separated by the shut-off valve 136. The flexible upper section 162 is connected at its upper end with an air inlet opening 164 (FIG. 7) formed at a top portion of the storage tank 20. It is to be appreciated that the use of a flexible upper section 162 advantageously enables end cover 42 to be pivoted freely about the hinges 44a,44b,44c when access to the tank interior 20a is required. The fixed section 160 of the diverter pipe 134 is mounted to and extends vertically upwardly from the discharge pipe 132 at a position spaced towards the inlet end 140 a distance of between about 4 to 16 inches upstream from the pipe 114. Fixed section 160 preferably has a vertical height selected not to substantially interfere with the pivotal movement of the end cover 42 to a fully open orientation.

Optionally, as shown in FIG. 8 the fixed section 160 may further include pressure release pipe 166, and regulator pressure relief valve 168. The release pipe 166 and valve 168 allow for depression of the tank interior 20a, with pressure relief valve preventing overpressure conditions which could result in possible damage to the truck 10 and/or operator injury. In a most preferred mode of operation, the pressure relief valve automatically allows for the release of pressure should internal tank pressure exceed 15 psi.

In use of the truck 10, following each discharge of the collected particulate material 12a, the regulator valves 168 are selectively actuated to equalize air pressure within the storage tank 20. Following equalization, the valves 168 are again closed and the float ball 82 lowered to allow the tank 20 to be evacuated.

In use of the truck 10, following collection of the reverts 12 using the waste collection assembly 22 in a conventional manner, the truck 10 is moved to transport the collected waste material 12a to silo 8 at a recycling facility. At the recycling facility the float ball 82 is raised into sealing contact with the valve seal 80. The outlet end 142 of the pressurizing discharge pipe 132 is coupled to the storage silo feed connector 152 (shown in phantom in FIG. 7) via coupling 144b. Concurrently, the pressurizing air pump 150 is fluidically coupled to the inlet end 140 of the pressurizing discharge pipe 132 via coupling 144a. With the air pump 150 connected, the outlet valve 148 is closed and the shut-off valve 136 is moved to an open position to allow airflow between the fixed section 160 and flexible section 162 of the pressure diverter pipe 134. The regulator and pressure release valves 168 are further closed, and the pressurizing air source 150 is actuated to induce a positive airflow into an along the discharge pipe 132 in a downstream direction of arrow 300. Initially as the air pressure pump 150 is activated, the outlet valve 148 is maintained in a closed position for air flow into the tank interior 20a, via diverter pipe 134 for a sufficient time to pressurize the tank interior 20a to reach a preselected positive pressure. In particular, with the outlet valve 148 closed, the airflow initially moves from the inlet end 140 upwardly through the diverter pipe 134 and into the tank interior 20a via the fixed and flexible hose sections 160,162. Preferably, the storage tank interior 20a is initially pre-pressurized to a minimum positive pressure, selected at between about 10 and 14 psi and more preferably about 13 and 14.5 psi.

Following initial pressurization of the tank interior 20a, the outlet valve 148 is opened. With the opening of the outlet valve 148, collected revert material 12a stored within the tank interior 20a moves both under gravity and as entrained particles together with a released primary pressurized airflow through the chute 110, discharging in the direction of arrow 200. As the revert particles 12a move from the tank interior 20a they pass through the discharge chute 110 and into the discharge pipe 132 via the outlet pipe 114. As the entrained revert particles 12a enter the discharge pipe 132, the secondary air flow 300 which moves directly along the discharge pipe 132 from the air source 150 and outwardly from the outlet end 142 further acts to entrain and move the collected revert particles 12a towards and from the outlet end 142, into the silo 8 via the fitting 152.

Most preferably the pressurizing air source 150 is operated to maintain an air flow along the pressurizing discharge pipe at a rate of between about 800 and 1000 cubic feet per minute, and more preferably about 950 cu-ft/min.

As heavier entrained revert material 12a enters the discharge pipe 132 downstream from the diverter pipe 134, air pressure increases in the discharge pipe 132 upstream from the outlet pipe 114. The pressure differential created results in air continuing to divert via pipe 134 into the tank interior 20a, maintaining its positive pressure and assisting in the forced movement of collected revert particles 12a outwardly therefrom through the outlet 50. In this manner, as the tank 20 is pressurized to a positive pressure, the discharge chute 110 is operable to permit one-way entrained particle flow in the direction of arrow 200 (FIG. 7) from the tank interior 20a via cut-out aperture 50, hopper box 112, outlet pipe 114 and into the discharge pipe 132. The revert particles moving into the discharge pipe 132 then travel in the direction of arrow 300 towards and outwardly via the discharge outlet end 142, moving via feed connector 152 (FIG. 7) into the storage silo 8.

Upon emptying of the storage tank 20, the pressurizing air source 150 is deactivated and uncoupled. The regulator valves 168 are again opened to depressurize the tank interior 20a, and the shut-off valve 136 and outlet valve 148 are closed, returning the truck 10 to a vacuum collection ready operation.

Although not essential, in another mode of operation to facilitate the emptying of the storage tank 20, the hydraulic lift cylinder 36 may be activated to raise the forward end 34 of the tank 20 relative to the rearward end 32. It is to be appreciated that as the retention chain 86 is used to maintain the float ball 82 within the ball cage 84 raised against the gasket 80, air is normally prevented from flowing outwardly along the vacuum inlet hose 66, allowing the storage tank interior 20a to be readily pressurized to a selected positive pressure by the air source 150. The higher gas pressure in the tank interior 20a facilitates the flow of collected reverts 12a from the tank interior outwardly through the cut-out aperture 50, through the discharge chute 110 and into the silo 8 via the discharge pipe 132. As the collected revert particles 12a are thus discharged from the discharge pipe 132 directly into the revert silo 8, the truck 10 permits the movement of collected reverts 12a from the tank interior 20a directly into the silo 8, whilst minimizing atmospheric entrainment of the collected material.

It is to be appreciated that the manifold assembly 130 may be provided with suitable shutoff valves 120, as well as optionally pressure relief valves (not shown) to allow the storage tank 20 to be safely pressurized. Suitable pressure gauges are preferably also provided to allow for the monitoring of the positive pressure in the system.

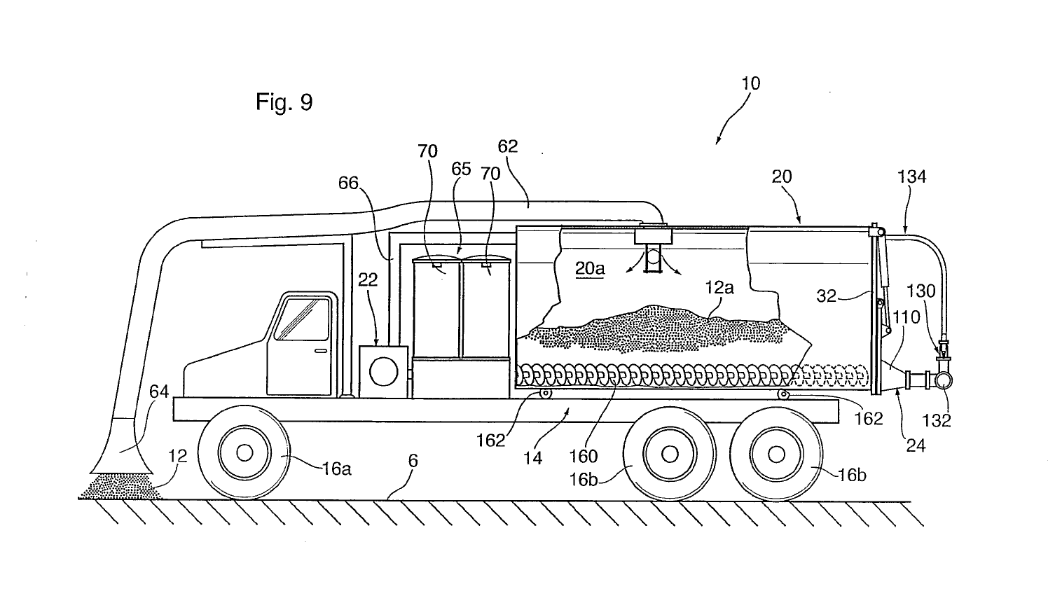

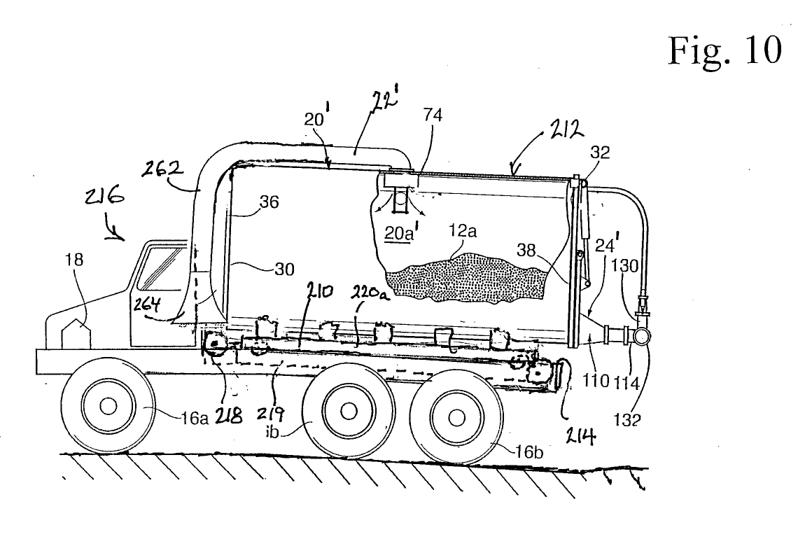

Although FIG. 1 illustrates the vacuum truck 10 as including a hydraulic lift cylinder 36 for use in assisting the emptying of the collector tank 20, the invention is not so limited. It is to be appreciated that the storage tank 20 could be fixed to the frame 14 against movement. In a further alternate construction, reference may be had to FIG. 9 which illustrates another embodiment of the invention, in which like numerals are used to identify like components. In FIG. 9, the vacuum truck 10 is provided with a mechanical screw auger 180 which is mounted for rotation within the collector tank interior 20a. The screw auger 180 is selectively operable to mechanically displace any collected reverts 12a towards the cut-out aperture 50, and therethrough into the discharge chute 110. The truck 10 may further be provided with one or more selectively activatable vibrators 182 which operate to impart a vibratory movement on the collection tank 20 to facilitate tank emptying.

Although the FIG. 1 illustrates the storage tank 20, waste collection assembly 22, and waste discharge assembly 24 as fixedly mounted to the frame 14 of a vacuum truck 10, the invention is not so limited. In an alternate construction, reference may be had to FIG. 10 which illustrates the storage tank 20′, waste collection assembly 22, and pneumatic waste discharge assembly 24′ are each mounted on a support frame 210 as part of a portable materials storage tank assembly 212, and wherein like reference numerals are used to identified like components.

In the embodiment shown the waste discharge assembly 24′ has essentially the identical construction and operation as the vacuum truck waste discharge assembly 24 shown with reference to FIGS. 2 and 5.

FIG. 10 shows the materials storage tank assembly 212 in transport, positioned on the bed 214 of a roll truck 216. The roll truck 216 is of a conventional design wherein the bed 214 includes a winch 218 and elevator 219 adapted for movement to an inclined position in the positioning of the materials storage tank assembly 212 thereon for transport; and its subsequent demounting therefrom onto the ground during waste particulate material collection, storage and/or discharge.

To facilitate the loading and unloading of the materials storage tank assembly 212 onto and from the roll truck bed 214, the storage tank 20′ may be provided with a tank interior 20a′ having a smaller volume than that used in the vacuum truck of FIG. 1. Preferably, however, the tank interior 20a′ has a volume selected at at least about 500 gal, preferably at least 1,000 gal and most preferably about 1,000 to 2,500 gallons. The waste collection assembly 22′ is provided with a tank suction hose 262 having a suction inlet 264. The suction hose 262 is provided for selective fluid communication with the tank interior 20a, via an inlet opening 74, and which is adapted for selective closure by way of the float ball assembly 76 in the same manner as is described with reference to FIG. 1.

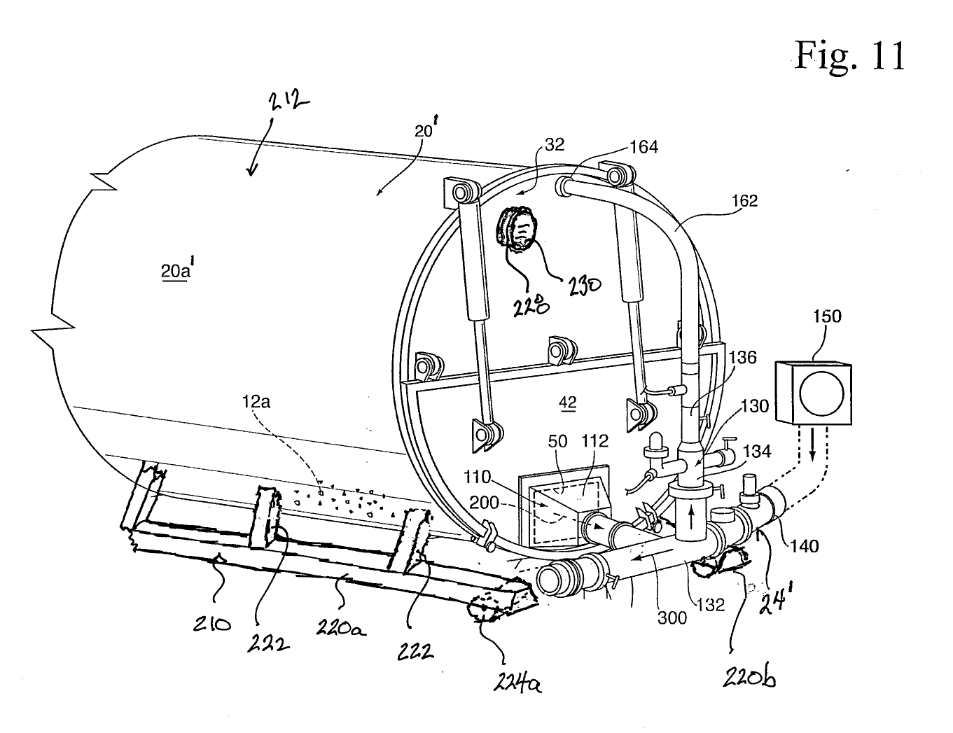

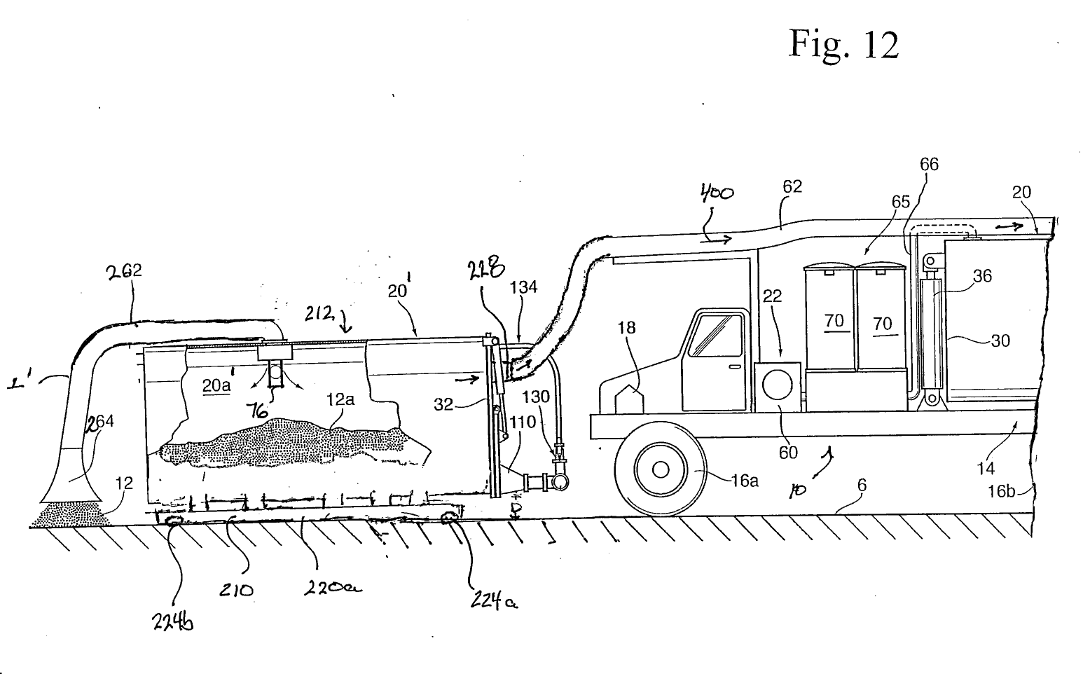

FIGS. 10 and 11 show best the support frame 210 as including a pair of parallel rails 220a,220b. The frame rails 220a,220b are arranged in a parallel orientation extending along each respective side storage tank 20′, and are secured thereto by a series of longitudinally spaced brackets 222. Each of the brackets 222 have a length selected such that a support frame 210 supports each of the storage tank 20′, waste collection assembly 22′ and waste discharge assembly 24′ distance D (FIG. 12) above the ground. The distance D is selected to maintain the necessary ground clearance between the storage tank 20′, waste collection assembly 22′ and waste discharge assembly 24′ during loading and unloading of the storage tank assembly 212 on to and from the roll truck 216. Typically the distance D is selected at between about 5 and 30 cm, depending on the truck bed 214 design. The support frame rails 22a are preferably each provided with a steel roller wheel, 224a,224b at each respective end to further facilitate storage tank assembly loading and unloading.

FIGS. 10 and 11 show best the storage tank 20′ as having a generally cylindrical construction extending rearwardly from a closed forward end 30 to a rearward end 32. As with the embodiment shown in FIG. 2, a hinged cover 42 is provided to selectively allow access to the tank interior 20a′ to facilitate cleaning or erupting.

A cut-out 50 formed in the bottom of the hinged cover opens to a hopper box 112 which is adapted for selective fluid communication of collected particulate material 12a along the discharge pipe 132. FIGS. 11 and 12 further shows the storage tank 20′ as provided with a suction inlet 228 which may be selectively opened or closed to allow fluid flow from the tank interior 20a′ by the removal or placement of a sealing cap 230 (FIG. 11). The suction inlet 228 further has a sized selected so that with the sealing cap 230 removed, the suction inlet 228 allows for the matted coupling with the suction inlet hose 62 of a vacuum truck 10 in the manner shown in FIG. 12.

As shown best in FIG. 12, in the collection of waste particular material 12 using the materials storage tank assembly 212, the sealing cap 230 is removed. The inlet hose 62 of a vacuum truck 10 then fluidically is coupled to the suction inlet 228. By activating the vacuum truck vacuum air pump 60, air is drawn into the vacuum truck tank 20 from the tank interior 20a′ via the truck inlet hose 62 (arrow 400), inducing a negative pressure therein. As with the storage tank 20 shown in FIG. 1, with the inducement of the negative pressure in the tank interior 20a′ air is drawn inwardly into the suction nozzle 264 to effect the entrainment and lifting of particulate material 12, resulting in its flow into the storage tank 20 via the opening 74. Whilst FIG. 12 shows the storage tank 20′ as including a float ball assembly 76 for the selective sealing of the opening 74 in the manner of the storage tank 20 shown in FIG. 1, the invention is not so limited. In a more simplified construction the storage tank 20′ could be provided with a replaceable cover or other mechanically sealing apparatus adapted for sealing placement over and removal from the opening 74 in the transportation and use of the storage tank assembly 212.

Most preferably, the suction inlet 228 is provided in an upper portion of the tank hinged cover 42. It is to be appreciated however, other positioning arrangements could be used.

With the storage tank assembly 212, following the collection of waste particulate material 12a therein, the storage tank assembly 212 may be left on site as a temporary storage facility or returned onto the roll truck bed 214 by way of the winch 218 and elevator 219 for transport to a suitable waste disposal or recycling facility. The applicant has appreciated that the storage tank assembly 212 provides a more economical container protecting the collected material therein from environmental exposure, degradation and/or contamination.

When desired, the stored collected waste particulate material 12a is erupted from the tank interior 20a′ so that the material storage tank assembly is prepared for re-use. At the waste or recycling facility, the waste discharge assembly 24 is then actuate to discharge the collected particulate material 12a from the tank 20 in the identical manner as previously described with reference to FIG. 1, and most preferably by the connection of a pressurizing air source 150 to the upstream end of the pressurizing discharge pipe 312.

Although the detailed description describes the use of a diesel motor 18 to provide power to the truck 10 and vacuum air pump 60, the invention is not limited. It is to be appreciated that other truck power plants could also be used including, without restriction, electric or gasoline motors, hydrogen fuel cells, and/or propane operated combustion engines. By way of non-limiting example, it is to be appreciated that an electric motor or fuel cell could alternately be provided to advantageously allow the truck 10 to be operated for larger periods in underground and/or confined spaces, without concern of CO or CO₂ gas contamination.

Although the detailed description describes the vacuum truck 10 as used in the collection of mine reverts in underground applications, the vacuum truck 10 is equally suitable for use in the collection of a variety of different types of solid and/or semi-solid material in both confined and unconfined spaces including, without restriction, other types of waste materials such as gravel, sand, litter and the like.

While the foregoing description describes the vacuum truck 10 as including a separate vacuum air pump 60 and pressurizing air pump 150, the invention is not so limited. In an alternate construction, the truck 10 could be provided with a single air pump which is either reversible, or provided with appropriate switchable-valving which operates to induce both positive and negative pressures within the tank interior 20a during waste discharge and collection operations.

While the detailed descriptions describes and illustrates various preferred embodiments, the invention is not to the specific preferred constructions which are shown. Many modifications and variations will now be apparent to persons skilled in the art. For definition of the invention, reference may be had to the appended claims.

We claim:

1. A truck mountable/demountable materials storage tank assembly for the collection, storage and discharge of waste particulate material to be collected, the materials storage tank assembly including:
a storage tank defining a tank interior and having a materials inlet and a materials outlet;
a waste collection assembly;
a waste discharge assembly; and
a support frame for movably supporting said storage tank, said waste collection assembly and said waste discharge assembly as a portable unit,
the storage tank assembly being adapted for selective coupling to both a pressurizing air pump assembly operable to induce a positive pressure within the tank interior, and an evacuating air pump assembly operable to induce a negative pressure in said tank interior,
the waste collection assembly including a vacuum inlet positionable to receive therein said waste particulate material to be collected and a vacuum conduit operable to provide fluid communication between the vacuum inlet and the materials inlet, when said evacuating air pump assembly is coupled to the storage tank assembly to induce said negative pressure in said tank interior, whereby on inducement of said negative pressure in said tank interior, the vacuum conduit communicates a vacuum fluid flow from said vacuum inlet to carry an entrained portion of said particulate material to be collected therewith into the tank interior,
the waste discharge assembly including an outlet end and a discharge conduit operable to provide fluid communication between the materials outlet and the outlet end, whereby when said pressurizing air pump assembly is coupled to the storage tank assembly to induce said positive pressure in said tank interior, the discharge conduit communicates a pressurized fluid flow to assist in carrying particulate material collected in said tank interior therewith to said outlet end, and
the support frame supporting said storage tank, said waste discharge assembly in a position elevated a distance above the ground.

2. The materials storage tank assembly as claimed in claim 1, wherein materials storage tank assembly is a roll-truck mountable assembly, the support frame further comprising a winch coupling for releasable coupling to a roll-truck winch in the mounting and demounting of the storage tank assembly thereon.

3. The materials storage tank assembly as claimed in claim 1, wherein said storage tank includes a longitudinally elongated cylindrical sidewall, a forward end, and a rearward end,
said support frame including a pair of parallel spaced, longitudinally elongated skid rails disposed respectively along each side of said cylindrical sidewall.

4. The materials storage tank assembly as claimed in claim 1, wherein said storage tank interior has a volume selected at at least 500 gal, and preferably at least 1,000 gal.

5. The materials storage tank assembly as claimed in claim 4, comprising a plurality of said air pump assemblies, said evacuating air pump assembly comprising a vacuum truck having a vacuum source and a vacuum suction hose in fluid communication with said vacuum source,
the storage tank including a suction inlet in selective fluid communication with the tank interior, said suction inlet adapted for fluidic coupling to said vacuum suction hose, wherein activation of said vacuum source draws air from said tank interior to induce said negative pressure therein.

6. The materials storage tank of claim 1, wherein the discharge conduit extends from an inlet end to said outlet end, and
the inlet end being connectable in fluid communication with said pressurizing air pump assembly, whereby operation of the pressurizing air pump assembly is operable to effect a pressurized air flow along said discharge conduit from the inlet end and outwardly therefrom via the outlet end.

7. The materials storage tank of claim 6, wherein the materials outlet further includes a discharge chute in fluid communication with a part of the discharge conduit intermediate said inlet end and said outlet end, whereby stored material carried with said pressurized fluid flow entering said discharge conduit is further carried with said pressurized air flow downstream towards said outlet end.

8. The materials storage tank of claim 7, wherein the discharge conduit assembly further includes a pressure diverter assembly operable to provide selective fluid communication between a portion of said discharge conduit upstream from the discharge chute and said tank interior, whereby on activation of said air pump assembly to effect said pressurized air flow, said pressure diverter assembly is actuable to selectively direct a portion of said air flow into said tank interior to induce said positive pressure therein.

9. The materials storage tank as claimed in claim 7 further including an outlet valve selectively operable to prevent or permit said air flow from moving through said outlet end.

10. The materials storage tank as claimed in claim 3, wherein the materials outlet is positioned adjacent a lowermost portion of said rearward end.

11. The materials storage tank as claimed in claim 5, wherein said materials inlet includes a valve assembly comprising a float ball and a valve seat,
the float ball being positionable between a seated position in generally sealing contact with said valve seat to substantially prevent fluid flow outward from said tank interior through the materials inlet, and an unseated position spaced therefrom, and wherein when said float ball is moved to said unseated position, inducement of said negative pressure in said storage tank effects said vacuum fluid flow from the vacuum inlet and into the tank interior via the materials inlet.

12. The materials storage tank as claimed in claim 9, wherein the rearward end comprises a selectively operable cover door, wherein the opening of the cover door allowing access to the tank interior, the discharge conduit being carried by said cover door for movement therewith.

13. The materials storage tank as claimed in claim 1, wherein the particulate material comprises mine reverts selected from the group consisting of mine tailings, crushed or waste rock.

14. A portable materials storage tank assembly for the collection, storage and discharge of waste particulate material to be collected, the materials storage tank assembly including,
a storage tank defining a tank interior and having a materials inlet, a materials outlet and a suction inlet, each of the materials inlet, materials outlet and suction inlet providing selective communication with the tank interior,
a waste collection assembly comprising a vacuum conduit in fluid communication with the materials inlet having a vacuum inlet being positionable to collect and receive therein at least part of said material to be collected,
a waste discharge assembly including a discharge conduit in fluid communication with said materials outlet and having an upstream end and a downstream outlet end,
a support frame supporting said storage tank, said waste collection assembly and said waste discharge assembly as a portable unit for transport,
the suction inlet being adapted for fluidic coupling to an evacuating air pump assembly operable to induce a negative air pressure in said tank interior, whereby fluid communication between the vacuum conduit and the tank interior effects a vacuum fluid flow into the vacuum inlet to carry an entrained portion of said particulate material therewith from said vacuum inlet into the tank interior,
the storage tank assembly being adapted for fluidic coupling to a pressurizing air pump assembly operable to induce a positive pressure within said tank interior, whereby fluid communication between said materials outlet and said tank interior effects a pressurized fluid flow from the materials outlet to assist in carrying particulate material collected in the tank interior therewith into the discharge conduit and from the material outlet end.

15. The tank storage assembly as claimed in claim 14, wherein said support frame supports said storage tank and said waste discharge assembly in a position elevated a distance of between about 5 cm and 40 cm above the ground.

16. The tank storage assembly as claimed in claim 14, wherein said pressurizing pump assembly comprises a vacuum pump truck having a vacuum source and a vacuum suction hose fluidically coupled to said vacuum source,
said suction inlet being adapted for selective fluidic coupling to said vacuum suction hose, wherein activation of said vacuum source draws air from said tank interior to induce said negative pressure therein.

17. The tank storage assembly as claimed in claim 16, wherein said tank interior has a volume selected at between about 500 and 2,500 gal.

18. The tank storage assembly as claimed in claim 17, wherein said storage tank includes a longitudinally elongated cylindrical sidewall, a forward end, and a rearward end,
said support frame including a pair of parallel spaced, longitudinally elongated skid rails disposed respectively along each side of said cylindrical sidewall.

19. The tank storage assembly as claimed in claim 17, wherein the materials outlet end is in selective fluid communication with a portion of said discharge conduit intermediate the upstream end and the outlet end,
the pressurizing air source being adapted for selective fluidic coupling to said upstream end, whereby operation of said pressurizing air pump assembly is operable to effect a pressurized air flow along said discharge conduit from the upstream end and outwardly therefrom via the outlet end to assist in the movement of collected particulate material therefrom.

20. The tank storage assembly as claimed in claim 19, wherein the discharge conduit assembly further includes a pressure diverter assembly operable to provide selective fluid communication between a portion of said discharge conduit upstream from the materials outlet and the tank interior, whereby on activation of the pressurizing air pump assembly said pressure diverter is actuable to selectively direct a portion of said pressurized air flow into said tank interior to induce said positive pressure therein.

21. The tank storage assembly as claimed in claim 20 further including an outlet valve selectively operable to prevent or permit said air flow from moving through said outlet end.

22. The tank storage assembly as claimed in claim 20, wherein said support frame supports said storage tank, said waste collection assembly and said waste discharge assembly for temporary portable transport by way of a roll truck.

23. The tank storage assembly as claimed in claim 18, wherein the rearward end comprises a selectively operable cover door, wherein the opening of the cover door allowing access to the tank interior, the discharge conduit being carried by said cover door for movement therewith.

24. The tank storage assembly as claimed in claim 22, wherein said materials inlet includes a valve assembly comprising a float ball and a valve seat,
the float ball being positionable between a seated position in generally sealing contact with said valve seat to substantially prevent fluid flow outward from said tank interior through the materials inlet, and an unseated position spaced therefrom, and wherein when said float ball is moved to said unseated position, inducement of said negative pressure in said storage tank effects said vacuum fluid flow from the vacuum inlet and into the tank interior via the materials inlet.

25. The tank storage assembly as claimed in claim 14, wherein said storage tank is a mine reverts storage tank, and said waste particulate material is selected from the group consisting of mine tailings, waste rock, and minerals.

26. The materials storage tank assembly as claimed in claim 1, wherein at least one said air pump assembly comprises a vacuum truck having a vacuum source and vacuum suction hose,
the storage tank further including a suction inlet in selective fluid communication with said tank interior, said suction inlet adapted for fluidic coupling to said vacuum suction hose, wherein the activation of said vacuum source draws air from said tank interior to induce said negative pressure therein.
